(19) United States
(12) Patent Application Publication
(10) Pub. No.: US 2009/0231223 A1
(43) Pub. Date: Sep. 17, 2009

(54) COMPACT REMOTE TUNED ANTENNA

(76) Inventor: Michael Laronda, Fairhaven, MA (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/371,068

(22) Filed: Feb. 13, 2009

Related U.S. Application Data
(60) Provisional application No. 61/065,788, filed on Feb. 14, 2008.

(51) Int. Cl. H01Q 7/00; H01Q 1/50

(52) U.S. Cl. 343/748; 343/868; 343/860

(57) ABSTRACT

A compact electrically long antenna including a manual or computer remote controlled tuning system using switched electrical length capable of operation at high RF power levels. An electromechanical relay or other switch device provides remote control (by a parallel binary bit pattern over great distance) of radiating structures formed of series connected absolute binary sequence electrical length radiating elements in a main circuit loop having a total electrical length. These radiating structures are formed from individual elements, and sets of individual elements, insulated and isolated from each other. The binary controlled switch devices may unshort (connect) and short out (bypass) binary length elements in the main loop circuit. The electrical length of the main loop circuit can be set to a desired length, from a maximum total length of all binary length elements in series to a minimum length where all binary elements are shorted out and effectively bypassed.

### CROSS REFERENCE TO RELATED APPLICATIONS

This application claims the benefit of U.S. Provisional Application No. 61/065,788, filed Feb. 14, 2008.

### FIELD OF THE DISCLOSURE

This disclosure relates to antennas which are compact and electrically long, are effective for frequencies from long wave to microwave, and have remotely tuned narrow bandwidths for use in radio communications. More specifically, the disclosure relates to compact antenna devices including planar, coplanar and combined planar/coplanar sets of radiating/receiving elements made of spaced apart conducting loops.

### BACKGROUND OF THE DISCLOSURE

The Amateur Radio Service of the United States and Amateur Radio Services of other countries are often the only communications services that remain working after the occurrence of natural and other disasters. There is a need in these services for a compact light weight antenna that can be easily stored in a hardened structure and then, when needed under post disaster conditions, transported and quickly set up without requiring long adjustments in a temporary tent or damaged, but usable, structure.

There is also a need for an antenna that is low profile; that trades off height and length for volume; and that can replace in operation at ground height the conventional tall monopole and long dipole antennas (as well as their supporting structures) now used for permanent point to point mobile and broadcast applications, with useable effective radiated power (ERP) results over the frequency ranges of VLF (very low frequency, nominally 3-30 KHz), LF (low frequency, normally 30-300 kHz), MF (medium frequency, nominally 300-3,000 kHz) and HF (high frequency, nominally 3-30 MHz) communications.

The advantages of such antenna devices have been recognized by amateur and professional planners of disaster communications since the early days of radio. Attempts to improve and develop such antenna devices have continued in more recent years with only moderate success.

The advantages of low radiation angle and horizontal polarization for long range HF communication have been recognized for many years and have driven the development of the HF beam and quad-type directional antennas to their present state in the art. However, the development of an omni-directional antenna with improved low radiation angle and horizontal polarization characteristics still leaves much to be desired. This is particularly true in the case of portable, compact omni-directional antennas which, because of their unique simplicity, are far more favorable for use in disaster communications than the larger, heavier and more complicated HF beam and quad antennas.

Because of their simplicity, omni-directional antennas are more adaptable to use with remote controlled tuning enabling operation from a location distant from the antenna itself. For example, in the case of a natural disaster, the omni-directional antenna might be erected on top of a damaged building, while the station itself could be controlled from a remote location. Also, under certain field conditions, where a generator and fuel supply are necessary, the antenna might be installed at a distance of several hundred feet from the operating position for safety and for mechanical and electrical noise considerations.

### SUMMARY OF THE DISCLOSURE

In accordance with the disclosure, a compact antenna device includes planar, coplanar and combined planar/coplanar sets of radiating/receiving elements made of spaced apart loops of wire, sheet metal, or other electrical conductors embedded, printed or plated on or in an insulating substrate material that is transparent to radio frequencies. Suitable substrates include ribbon wire and circuit board with the width, diameter, thickness, length and spacing of the conductors ranging in size from meters to millimeter and in configurations that maximize useful radio frequency (RF) radiation in a horizontal direction plane with high phase coherency of radiation and optionally including a remote controlled tuning capability.

An improved compact antenna embodying the disclosure may replace the high radiation efficiency, full size electrical length dipole and monopole antennas commonly used in VLF to microwave frequency ranges, and can efficiently transmit RF energy in a reduced volume, length, width and height package, both in temporary and in permanent applications. Such a compact antenna may also have remote controlled tuning over entire bandwidth ranges of the VLF, HF and microwave frequency bands.

Furthermore, in accordance with the disclosure, an improved antenna system is provided for introducing RF energy at high RF current levels to an antenna-radiating element, which has a low series inductance value to reduce voltage across the element. Such an improved antenna system may be compact and efficient and have an improved receive aperture that can support remote indoor or outdoor operation.

An improved compact antenna system according to the disclosure may be configured for omni-directional, horizontal, low angle of radiation operation in a relatively small package and at the same time can be operated at high RF power levels; the system may also include an RF tuning component that can tune the antenna at high RF power levels from a remote location. The antenna may be configured and fitted to a number of existing towers, supports and other structures.

In addition, an RF tuning apparatus is provided for tuning a compact antenna that can efficiently handle high RF power levels of greater than about 1500 watts RMS, and may remotely tune a compact antenna system at high RF current levels. In an embodiment, this RF tuning apparatus has a minimum number of moving parts, may be configured for a number of bands and be tuned relatively quickly within a given band, and may be housed in a small waterproof box at an antenna location remote from the transmitter and receiver.

In accordance with the disclosure, a simple and reliable parallel interface capability may be provided to a wide variety of remotely located computer devices in order to support automatic program control and turning of an antenna system.

Furthermore, in accordance with the disclosure, an improved compact antenna system is provided that is configured for omni-directional, isotropic all angle radiation operation in a relatively small package, and which at the same time can be operated at high RF power levels.

### BRIEF DESCRIPTION OF THE DRAWINGS

FIG. 1 is an electrical schematic view of an antenna system in accordance with an embodiment of the disclosure.

FIG. 1A is a detail view of a capacitor/inductor series circuit for use in the system of FIG. 1, to improve the effective radiated power (ERP) of the system.

FIG. 1B is a detail view of a capacitor/inductor circuit for use in the system of FIG. 1, to improve tuning of the system for maximum ERP.

FIG. 2 is a schematic diagram illustrating planar RF radiation emanating from a less than ½ wavelength loop.

FIG. 3 is a schematic diagram illustrating planar RF radiation emanating from a coplanar stack of a set of two less than ½ wavelength loops connected in a series circuit.

FIG. 4 is a schematic diagram illustrating planar RF radiation emanating from a series connected set of five less than ½ wavelength rectangular loops.

FIG. 5 is an electrical schematic view of a single round loop that with connection leads form a less than ⅛ wavelength coplanar loop antenna with apparatus normally required to tune and match that antenna.

FIG. 6 is an electrical schematic view of a set of two round loops of the FIG. 5 description type in series connection that with leads form a less than ¼ wavelength coplanar loop set antenna with apparatus normally required to tune and match such an antenna.

FIG. 7 is an electrical schematic view of a set of four round loops of the FIG. 5 type in series connection that form a less than 1 wavelength greater than ½ wavelength coplanar loop set antenna with apparatus normally required to tune and match such an antenna.

FIG. 8 is an electrical schematic view of a set of eight round loops of the FIG. 5 type in series connection with leads that form a 1 wavelength loop antenna with apparatus normally required to match such an antenna.

FIG. 9 is an electrical schematic view of a single planar square loop in the plane indicated.

FIG. 10 is an electrical schematic view of a single planar set of four wide spaced series connected rectangular loops in the plane indicated.

FIG. 11 is an electrical schematic view of a single planar set of four very close spaced series rectangular loops in the plane indicated.

FIG. 12 is an schematic view of two of FIG. 9 planar loops in a coplanar arrangement in and above the plane indicated;

FIG. 13 is a schematic view of a combination of two FIG. 11 single planar sets of four very close spaced series connected rectangular loop sets mounted over four rectangular planar close spaced series connected loops to form a coplanar set of planar loop sets.

FIG. 14 is a schematic view of FIG. 13 coplanar loop set with connection method to form a set of eight planar loops.

FIG. 15 is a side view of FIG. 14 showing radiation and placement of energy guide plates.

FIG. 16 is a top view of FIG. 14 showing omni directional horizontal radiation from the set of planar loops.

FIG. 17 is a planar set of close spaced wire loops with a binary 1:2:4 length ratios with leads back to a set of relays, where insulated wire is used.

FIG. 18 is a planar set of printed wire circuit board loops with a binary 1:2:4 length ratios with leads back to a set of relays, where insulation by board gap space is used.

FIG. 19 is an exploded view showing a part of a loop stack assembly with an arrangement of energy guide plate, flat insulator plate, planar loop set, inside cavity insulator, flat insulator plate, energy guide plate, flat insulator plate, second planar loop set, cavity insulator, and flat insulator plate.

FIG. 20 shows a top view of a portable or mobile unit with a plastic cover over an aluminum base plate.

FIG. 21 shows a side view of the portable or mobile unit with the plastic cover removed.

FIG. 22 depicts a land vehicle with isotropic all angle radiation type unit, suitable for ground to air and short range ground to ground communications.

FIG. 23 depicts a vessel with omni directional low angle long range low angle radiation type unit mounted below radar antenna on a mast.

FIG. 24 shows an aircraft with isotropic all angle radiation type unit, suitable for air to ground and air to air communications.

FIG. 25 shows an emergency shelter set up with an isotropic all angle radiation type unit.

FIG. 26 schematically illustrates an antenna system including an RF input section circuit and a control monitor connected by a wire buss.

FIG. 27 schematically illustrates an antenna system as in FIG. 26, with the addition of a remote controlled inductance device.

FIG. 28 schematically illustrates an antenna system as in FIG. 27, with the addition of a second remote controlled inductance device and a remote controlled capacitor device.

FIG. 29 schematically illustrates an antenna system as in FIG. 26, with the addition of a twin “T” manual adjustable matching device, capacitor devices and a manual adjustable inductor device.

FIG. 30 schematically illustrates an antenna system as in FIG. 26, with the addition of a fixed capacitor ratio twin “T” remote controlled adjustable inductor device and a fixed matching capacitor device.

Like reference numbers and designations in the various drawings indicate like elements.

### DETAILED DESCRIPTION

The term “electrical length,” when used herein, means the length of a conductor corrected for the speed of light in that conductor (a wire or other type of conductor, or transmission line device).

In the embodiments described herein, an electromechanical relay or other switch device is used to control, remotely and by a parallel binary bit pattern, one or more arbitrary radiating structures. These structures are formed of series connected, absolute binary sequence electrical length radiating elements in a main circuit loop; the main loop is characterized by a total main loop electrical length. The radiating arbitrary structures are formed from individual electrical length elements, and/or sets of elements insulated and isolated from each other. These binary electrical length elements may also be insulated and isolated by 1:1 balun or other transformer devices. The binary length elements may be connected to switch devices by wire or coax cable. The binary controlled switch devices may un-short (and thereby connect or disconnect), or short out (and thereby bypass) the binary length elements in the main loop circuit. The electrical length of this main loop circuit can be set to a desired length, which may range from a maximum length given by the total length of all the binary length elements in series (un-shorted) to a minimum length where all the binary elements are shorted out and effectively bypassed. This operation can be performed by a remote control, by establishing a binary control bit pattern by manual or computer or other automatic means. This binary control bit pattern can then be sent over the control cable, over a great distance, to control switch devices in a binary pattern. The ascending binary electrical length radiating elements of a main loop can be any combination of radiating structures; loop, dipole or monopole. The electrical length of this arbitrary structure is adjusted to natural fundamental or harmonic resonance conditions. The establishment of such resonance conditions simplifies the requirements to match a standard transmission line to antenna to a very efficient wide band 1:1 type transmission line or other 1:1 transformer device. Adjustment of the main loop length, and use of a 1:1 transformer, can effect an efficient matching condition to coax cable in the 35 ohm to 52 ohm characteristic impedance range with very low standing wave ratios, so as to assure a very high effective radiated power level.

In an embodiment, the radiating structure comprises a set of planar conducting loops having an electrical length of less than ½ wavelength, in a series connection with switching devices (e.g. relays). In other embodiments, the radiating structure may comprise a set of coplanar loops, or a set of planar and coplanar loops in combination.

In alternative embodiments, one or more of the radiating structures may comprise

(a) a dipole device having an electrical length of less than ½ wavelength, with a balun, coax cable, and balun in a switched series circuit connection;

(b) a monopole device having an electrical length less than ¼ wavelength, with a balun, coax cable, and balun in a switched series circuit connection;

(c) a set of planar loops in a series connection, the loops having a rectangular, square, round or some other shape and having an electrical length of less than ½ wavelength, with a wide spacing of loops, to produce low angle linearly polarized omni directional horizontal radiation;

(d) a set of planar loops in a series connection, the loops having a rectangular, square, round or some other shape and having an electrical length of less than ½ wavelength, with a narrow spacing of loops (that is, about ¼ inch between the planes of neighboring loops), to produce all angle isotropic type un-polarized radiation;

(e) a set of coplanar loops in a series connection, the loops having a rectangular, square, round or some other shape and having an electrical length of less than ½ wavelength, with a wide spacing of loops, to produce low angle linearly polarized omni directional horizontal radiation;

(f) a set of coplanar loops in a series connection, the loops having a rectangular, square, round or some other shape and having an electrical length of less than ½ wavelength, with a narrow spacing of loops, to produce all angle isotropic type un-polarized radiation;

(g) a set of planar and coplanar loops in combination, in a series connection and having a rectangular, square, round or some other shape and having an electrical length of less than ½ wavelength, with a narrow spacing of loops, to produce all angle isotropic type un-polarized radiation; or

(h) a set of planar and coplanar loops in combination, in a series connection and having a rectangular, square, round or some other shape and having an electrical length of less than ½ wavelength, with a wide spacing of loops, to produce low angle linearly polarized omni directional horizontal radiation.

In any and all of the above arrangements, the loop sets, when switched into the main loop, contribute to the main loop length. Accordingly, the main loop length may be adjusted by switching selected elements to effect an efficient matching condition to coax cable in the 35 ohm 52 ohm characteristic impedance range with very low standing wave ratios. Using a 1:1 transformer assures a very high effective radiated power level.

An antenna system according to the disclosure has a series arrangement of closely spaced apart, small, rectangular or circular loops stacked together in a plurality of sets, each set being separately connected electrically via separate relays for each set of loops. The tuning device can be manual or automatic, which in the case of the latter would be digitally controlled to achieve minimum SWR (standing wave ratio, a measure of how much radio energy being sent into an antenna system is being reflected back to the transmitter). The manual or computer controlled remote tuning system has a set of switched planar, coplanar or combined planar/coplanar loop radiating receiving loop element sets, connected in a series circuit. The total inside loop perimeter length of all loop set series loops, added to the total length of the wires connecting the loops in a set to each relay switch device contact, is made to be a specific total length. The relay contacts are arranged to disconnect series loop element sets and bypass loop element sets if relays are un-energized. A typical total of 16 relay devices are employed to disconnect and bypass series loop element sets into and out of a main RF series loop circuit. In addition, in series with this main RF circuit loop, a 1:1 type wide band transmission line balun device may be connected. This balun device, in series with all other main loop switched elements, is used to output received RF signals to a coaxial cable with connection to coax through a standard, female type, UHF (ultra high frequency, nominally 300-3000 MHz) or other panel connector device.

This main loop circuit has the series connected, relay switched, planar, coplanar and combined planar/coplanar collection of radiating/receiving series loop set elements with total loop set lengths arranged in a descending absolute binary electrical length sequence. The electrical length of individual loop set elements is arranged in a binary sequence: 2⁰, 2¹, 2², 2³, 2⁴, . . . , 2ⁿ. The loop set elements thus have lengths in the ratio 1:2:4:8:16 and so forth. The shortest wire length may be 1 meter, 1 ft, 1 inch, 1 cm, etc.; the other wire lengths are then multiplied according to the sequence 2, 4, 8, 16, . . . , 2ⁿ. In the embodiments described herein, the basic (shortest) length is taken to be 1 ft.

In an exemplary embodiment, 16 relays are arranged in parallel to form a sequence ranging from a least significant bit, LSB (0) to a most significant bit, MSB (15); accordingly, the control lines for the relays express a binary code value. When the control lines of the 16 relays are energized with a LSB to MSB digital code bit pattern, the electrical length in feet is the decimal number equivalent of the binary code value. In actual operation any energized relay is a binary 1 and any un-energized relay is a binary 0 value. The LSB bit is the control line status of the relay that is switching the shortest length of wire; the MSB bit is the control line status of the relay that is switching the greatest length of wire with all relay status bits in ascending order according to the lengths of wire switched. The total length of a switched loop set is given by the perimeter lengths of the loops plus the length of the loop connecting wires. For example, if the length of the wires connecting the loops to the relays is 5 ft, then a setting for a decimal value of 975 feet of loops, plus 5 ft of typical inter relay and other main loop series wire, will cause the main loop to have 980 ft of electrical length. The coaxial connector will present a good 1.11 SWR to 1.2 SWR match to 50 ohm signal source of approximate frequency of 936/980=0.960 MHz frequency. The fact that the main loop electrical length can be set to any maximum to minimum length value permits the main loop to be remotely set to any frequency (in theory) remotely by relays from a total loop length value in feet divided into 936, to a minimum loop set length (that is, the shortest loop set length in feet) divided into 936. If this length is 25 ft, then the corresponding frequency is 936/25=37 MHz. The actual range can be less by about 20 percent on each end of the range due to loop to loop capacitance, mutual inductance and other effects. The above-described binary loop gives the widest tuning range for the least amount of loop conductor/wire and switching relays and is accordingly a desirable configuration for remote control by a digital computer parallel output port.

Some portable, fixed and mobile applications for the present antenna in the HF frequency range include: amateur radio service transmitting and receiving, and receiving short wave listening with reduced signal fade. Some special MF frequency range applications include: low power AM radio broadcast for public service information and traffic warnings and advisories; private AM broadcast systems for ski and other resorts; high power AM broadcast station use as primary and emergency antenna or split site applications; FM broadcast band and television broadcast receiving applications; and VHF, UHF and microwave communications services. Some particular MF to long wave applications include: affordable two way underground-to-surface communications (e.g. from coal and other mines) for normal and emergency communications; and underground natural resource exploration for commercial and scientific research applications.

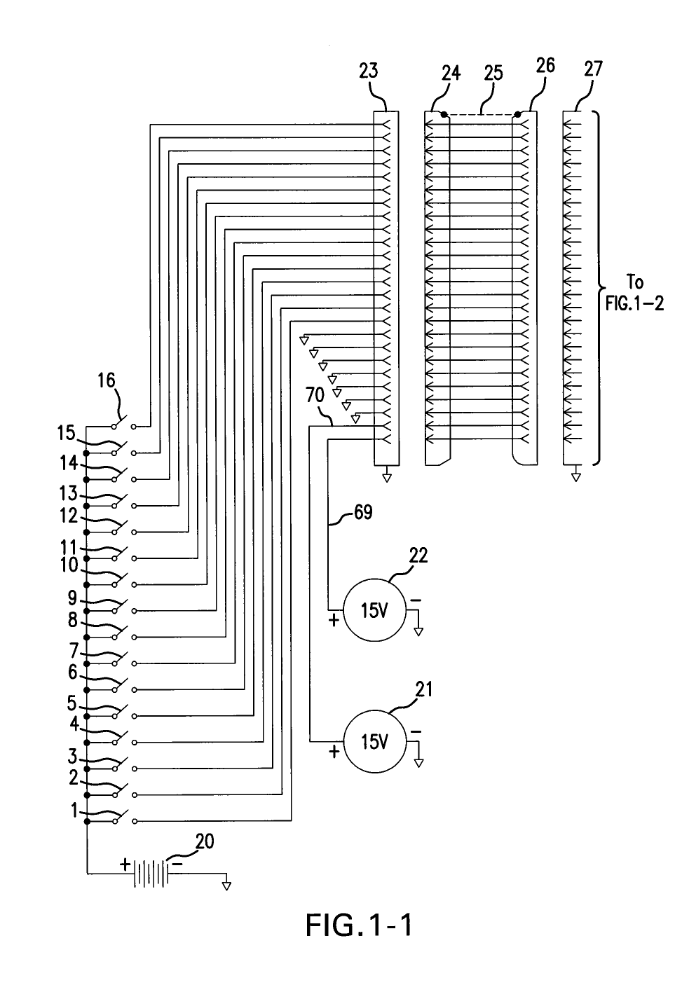

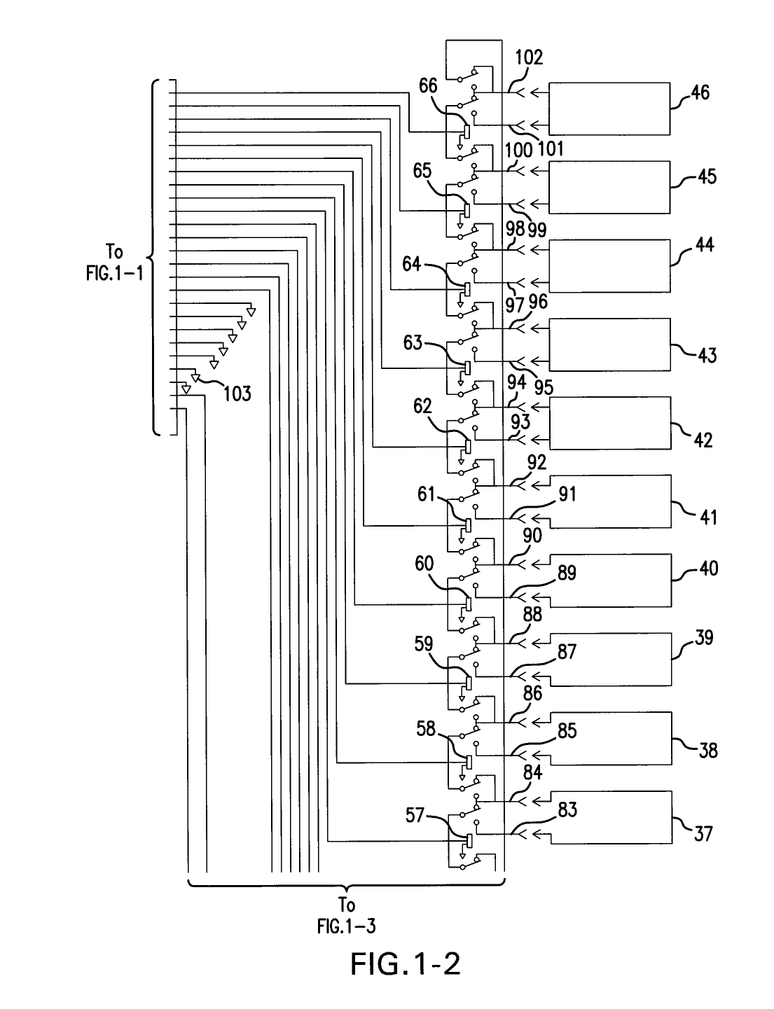

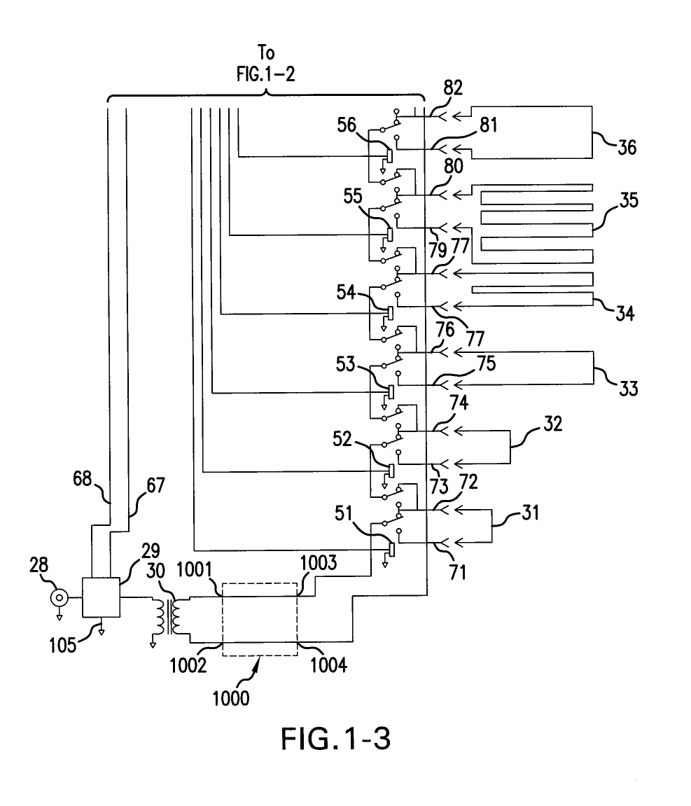

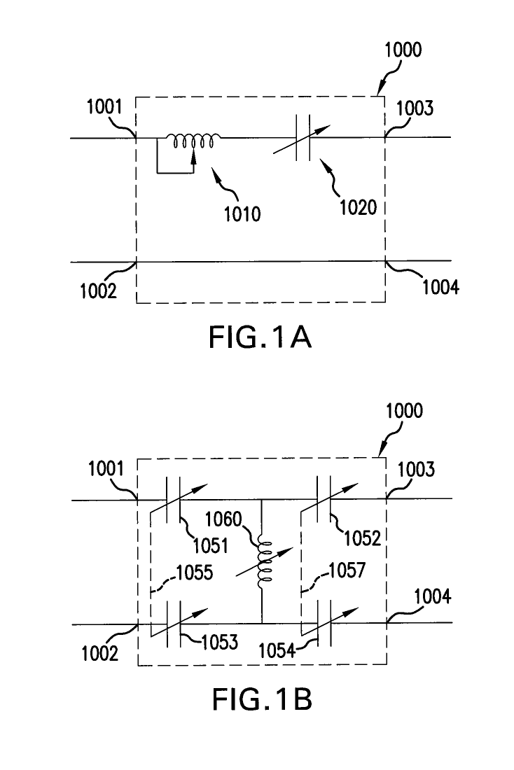

FIG. 1 illustrates an embodiment of a compact remote tuned antenna having planar co-planar and combined planar co-planar loop sets of rectangular loop antennas of varying descending binary lengths (that is, lengths expressed as powers of 2). Exemplary is planar loop set 35 across terminals 79, 80 of length 16 ft, in combination with planar loop set 34 across terminals 77, 78 of length 8 ft, in combination with planar loop set 33 across terminals 75, 76 of length 4 ft, in combination with planar loop set 32 across terminals 73, 74 of length 2 ft, in combination with planar loop set 31 across terminals 71, 72 of length 1 ft. Operation of relays 51, 52, 53, 54, 55 permits the selection of all antenna lengths from 1 ft to 31 ft in 1 ft increments. Each individual loop and the connecting wire are counted in the total loop set length connected to the relay terminals.

The terminals described herein are generally standard wire, spade-lug, banana-jack terminals. Planar loop 31 connected across terminals 71, 72 is 1 ft in length. Planar loop 32, connected across terminals 73, 74 is 2 ft in length. Planar loop 33 connected across terminals 75, 76 is 4 ft in length. Planar loop set 34 connected across terminals 77, 78 is 8 ft in length. Planar loop set 35 connected across terminals 79, 80 is 16 ft in length. Coplanar loop set 36 connected across terminals 81, 82 is 32 ft in length. Coplanar loop set 37 connected across terminals 83, 84 is 64 ft in length. Coplanar loop set 38 connected across terminals 85, 86 is 128 ft in length. Coplanar loop set 39 connected across terminals 87, 88 is 256 ft in length. Planar loop set 40 connected across terminals 89, 90 is 512 ft in length. Planar loop set 41 connected across terminals 91, 92 is 1024 ft in length. Planar loop set 42 connected across terminals 93, 94 is 2048 ft in length. Planar loop set 43 connected across terminals 95, 96 is 4096 ft in length. Planar loop set 44 connected across terminals 97, 98 is 8192 ft in length. Planar loop set 45 connected across terminals 99, 100 is 16384 ft in length. Planar loop set 46 connected across terminals 101, 102 is 32768 ft in length. Planar loop sets 42-46 may be used to verify operation from 0.014 MHz to 35 MHz.

In the construction of this embodiment, the individual planar loops 31, 32 and 33 are made from stranded (number 14) 600 volt insulated wire tacked to ⅜ inch thick wood panels with standard wire tacks. The individual planar loop sets 34 and 35 are constructed of stranded (number 14) 600 volt insulated wire tacked to a ⅜ inch thick wood panel with standard wire tacks as two series connected rectangular planar loops. The individual loops in these sets are generally rectangular, 1.5 ft by 0.5 ft. The length of the four long loop wires is approximately 1.5 ft long with 2 inch spacing. The individual planar loops of coplanar loop sets 36, 37, 38, 39 are constructed of stranded (number 14) 600 volt insulated wire mounted above each other in a vertical wood insulating frame with the coplanar space between individual loops being nominally 5 inch. The individual coplanar loops of loop sets 36, 37, 38 and 39 are 2 ft by 2.5 ft when mounted in a frame; the length of a loop with a 1 ft lead length is 10 ft. To form the 32 ft total length loop, 3 coplanar loops of 10 ft are mounted and 2 ft of wire used for leads. To form the 64 ft total length loop, 6 coplanar loops of 10 ft are mounted and 4 ft of wire used for leads. To form the 128 ft total length loop, 12 coplanar loops of 10 ft are mounted and 8 ft of wire used for leads. To form the 256 ft total length loop, 24 coplanar loops of 10 ft were mounted and 14 ft of wire used for leads; the 12 ft structure of 24.5 ft spaced loops was made in two approximately 6 ft tall frames. The 14 ft length of lead wire in the 256 ft total was used to interconnect the two coplanar loop frames. To verify operation from 460 kHz to 30 MHz, two temporary planar rectangular closely spaced loops were constructed of 512 ft and 1024 ft of stranded number 14 600 volt insulated wire. Construction of these loops was accomplished by laying out twenty 25 ft long wires with 5 inch spacing to form ten 25 ft by 5 inch spaced rectangular loops. The same procedure was used for the 1024 ft loop to form loops 40 and 41 shown schematically in FIG. 1.

As shown in FIG. 1, four contact standard RS232 connectors 25 are used. Connector 23 is a fixed chassis mount contact female connector; connector 24 a movable contact male connector; connector 26 a movable contact female connector; and connector 27 a fixed chassis mount contact male connector.

As shown in FIG. 1, at connectors 23-27 wires 69 and 70 connect to wires 68 and 67 respectively, wire 103 serves as a common chassis ground return, and the sixteen relays 51-66 connect to a tuning box with an array of sixteen switches 1-16, described in more detail below.

Closing switch 1 connects 12 VDC source 20 to relay 51, which energizes relay 51 and un-shorts and connects loop 31 (1 ft long). Closing switch 2 connects 12 VDC source 20 to relay 52, which energizes relay 52 and un-shorts and connects loop 32 (2 ft long), and so forth.

A local manual control monitor tune box includes connector 23, wiring conductive chassis common ground, single pole single throw (SPST) switches 1-16, forward SWR indicator display 12 volt DC meter 22 reverse SWR indicator display meter 21 and 12 volt battery 20. Note that battery 20 can be replaced by a 12 VDC type power supply in some applications. The local manual control monitor tune box may be constructed in various waterproof cases for outdoor use, as well as rack panel instrument cases for indoor use. Various on/off switch indicator lamps and fuse arrangements may be used, as is known to those skilled in the art. Other improvements, such as transient diodes and transient suppressor devices to prevent switch erosion, may be readily implemented by those skilled in the art.

In this embodiment, the remote control monitor tune box also includes connector 27; wiring conductive chassis as common ground 103; connector 28; sensor 29; transformer 30; relays 51-66; and spade lug connectors 71-102. The remote control monitor tune box is a plastic NEMA (National Electrical Manufacturers Association) style outside power plastic junction box the antenna loop set leads are all connected by spade lug banana wire jack connectors through individual holes in side of plastic NEMA type box. If a metal box is used the spade lug connectors can be insulated by rubber grommets or other suitable insulators.

The sixteen contacts of connector 27, connected to the respective planar loop sets 31-46, may be viewed as control bits for the remote control box. The contact for loop set 31 is the LSB binary control bit 0; the contact for loop set 46 is the MSB binary control bit 15.

Device 30 is a one to one wide band transmission line transformer made of ten turns of number RG 58-coax cable on an AMIDON FT-240-K core device (Amidon Inc. Casa Mesa, Calif.). Connector 28 is an UHF type coax panel connector. Device 29 is a standard 50-ohm coax input and output SWR power sensor device. Wire 68, connected to wire 69 through the connectors described above, is the forward SWR signal voltage line to remote display unit meter 22. Wire 67, connected to wire 70, is the reverse SWR signal voltage line to remote display unit meter 21. The return signal voltage from the remote display units is returned through common ground 105. Connector 27 has several pins connected to the common ground and return line through cable 25, as shown schematically in FIG. 1.

In this embodiment, cable assembly 25 is a standard shielded plastic molded 25-wire straight wired connector contact (PHILMORE ROCKFORD, Ill. 51109 U.S.A. RS232 DATA CABLE FULL SHIELD-DB25 MALE/FEMALE 100 FT. STRIGHT THRU WIRING NO. 70-2580) to contact one to one RS-232 standard cable assembly. Antenna control and monitor lines are connected from manual control to using this cable. Remote control may be performed with cables at least as long as 400 feet.

In the embodiment shown in FIG. 1, relays 51-66 are type Magnecraft General Purpose Relays DPDT 15 A, MINI POWER Mfg Part NUMBER: 782XBXM4L-12D. In mounting the relays to a board or chassis, Magnecraft Relay Sockets and Accessories Mfg P/N 70-401-1 8 PIN SOLDER TERM may be used.

The radiating elements shown in FIG. 1 are generally folded with close spacing, as schematically illustrated in planar loop sets 34 and 35 of FIG. 1. This has an effect on the observed self-inductance of the radiating elements. In the case of a long wire or a large circular or square loop, this inductance is obtained from the physical length: the length of the loop in ft (or a section of a loop element spacing with physical length in ft) when multiplied by 0.384 micro henry/ft., corresponds to the universal permeability constant 1.26×10⁻⁶ henry/meter converted to 0.384 micro henry/ft. When the conductor is folded with close spacing, however, the self-inductance is reduced, and may approximate 0.192 micro henry/ft (that is, half the amount for an unfolded conductor), which in turn increases the value of the self-resonant frequency by a factor of 4. This effect has been observed in the closely spaced folded loop sets used in the embodiment of FIG. 1, over the frequency range 1.8 MHz to 800 MHz. It has also been observed that the reduced inductance at resonance conditions, due to closely spaced planar loops as in FIG. 1, results in reduced effective radiated power (ERP). This problem is addressed by adding a circuit as shown in FIG. 1A at location 1000 (that is, between the balun device 30 and the array of planar loop sets). The two wires connecting the balun device and the planar loop sets connect with this circuit at terminals 1001-1004, as shown in FIG. 1A. The circuit includes a binary switched inductor 1010 in series with a variable capacitor 1020; the capacitor is preferably variable in the range 0.7 pF to 1000 pF and has a high voltage rating (20000 V or more).

FIG. 1B schematically illustrates a tuning circuit that may advantageously be located at 1000 in the system of FIG. 1, in order to maximize ERP output of the antenna system. Variable capacitors 1051, 1052 are connected in series between terminals 1001 and 1003; variable capacitors 1053, 1054 are connected in series between terminals 1002 and 1004. Capacitors 1051-1054 are all variable from 2 pF to 2000 pF. Pairs of capacitors 1051, 1053 and 1052, 1054 may be tuned together, for example by being turned from common insulated rotor shafts shown schematically at 1055, 1057 respectively. A variable inductance 1060 connects the junctions between the pairs of capacitors, as shown. With this circuit added to the arrangement of FIG. 1, it has been observed that the planar loop array electrical length may be set to ⅝ to ⅞ of a wavelength for the frequency of interest, while the capacitors 1051-10545 and inductor 1060 are used to adjust the antenna for resonance; a 1:1 SWR may then be obtained.

It will be appreciated that relays 51-66, with their associated contacts and connectors, together comprise a relay switching device for the antenna system; this device is advantageously remotely controlled.

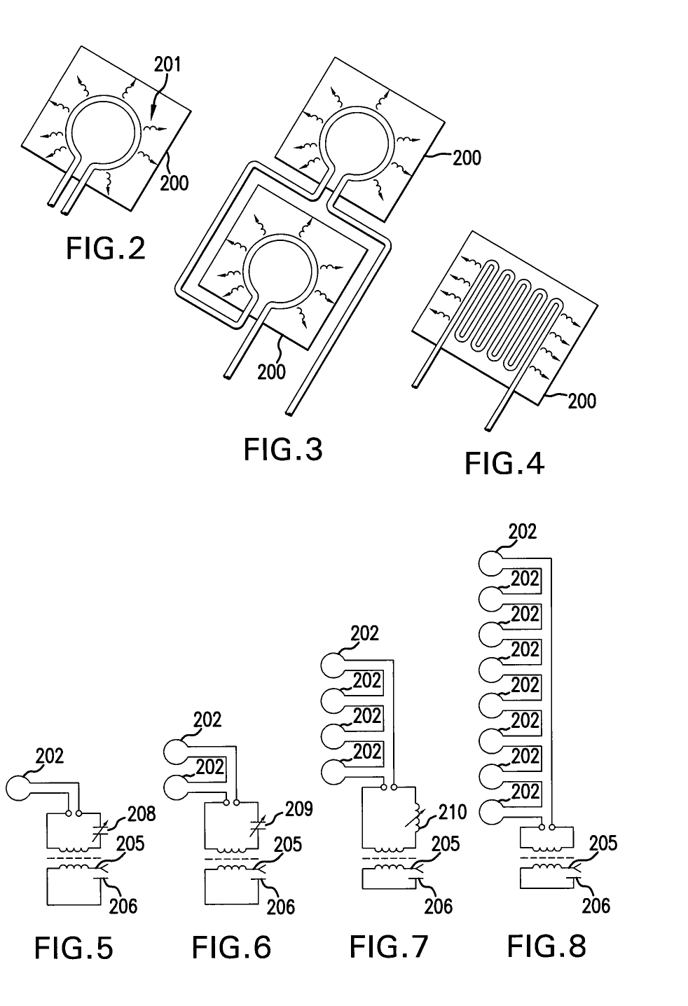

A simple radiating structure, illustrated in FIG. 2, is a less than ½ wavelength perimeter planar loop, with emitted planar radiation symbol 201. The radiation pattern indicated in plane 200 is also the same general type planar low angle radiation pattern that has been observed to occur in square and triangular loops and rectangular loops with length to width ratio of 2:1. FIG. 5 depicts a round, approximately 5.25 ft diameter and 16.5 ft perimeter loop, which may be a fraction of a wavelength (perhaps less than ⅛ of a wavelength). FIG. 5 also depicts a circuit and devices used to tune and match the loop to a standard 50-ohm transmission line and transmitter. The transformer device 205 in this case has approximately a 64:1, 500:1 and 10,000:1 turns ratio, to produce radiation across the respective frequency ranges of 7 to 7.3 MHz, 3.5 to 4 MHz and 0.505 to 0.510 MHz. With 100 watts of power input, ranges of 25 miles (day or night) may be obtained, with a low angle radiation pattern in plane 200 as depicted in FIG. 2. With loop 202 mounted in a horizontal or vertical plane approximately 20 to 22 ft off earth ground radiation is as shown in FIG. 2. In all planes, when the loop was mounted relative to earth ground the received polarization was in the same plane. To observe the above-described pattern, a 3.5 ft diameter one turn loop with a balanced input gain of 100 from a pre-amp circuit device and receiver was used. FIG. 6 depicts circuit and devices used to tune and match loops to a standard 50-ohm transmission line and transmitter.

FIG. 3 depicts a set of two less than ½ wavelength perimeter planar loops in a series circuit, coplanar arrangement and radiation symbols 201 depicting a low angle omnidirectional radiation pattern in plane 200. Radiation may be produced as shown in FIG. 3 and FIG. 4 in the 7 to 7.3 MHz, 3.5 to 4 MHz and 0.505 to 0.510 MHz frequency ranges with 100 watts of power input, with ranges up to 25 miles. As with the single loop of FIG. 2, to observe the radiation pattern a 3.5 ft diameter single turn loop with balanced input gain of 100 from a pre-amp circuit device and receiver was used. FIG. 6 depicts circuit devices and arrangement of devices used to produce FIG. 3 radiation pattern over 7 to 7.3 MHz 3.5 to 4 MHz and 0.505 to 0.510 MHz frequency ranges. FIG. 4 depicts a set of 5 less than ½ wavelength perimeter planar loops in a series circuit in a planar arrangement; radiation symbols 201 depict a low angle partly directional radiation pattern in plane 200.

An unexpected result is observed when two more 12.5 ft perimeter loops of FIG. 3 are combined: The measured real part radiation resistance increases to the real part radiation resistance expected for an equivalent of a 50 ft dipole or 25 ft monopole antenna with ideal ground with equal electrical length for the frequency of operation. This has been observed in the arrangements of both FIG. 3 and FIG. 4, when (1) two additional co-planar loops were added to the arrangement of FIG. 3 with same relationship and wired for lowest inductance, and (2) after five more loops (in plane 200) were added to FIG. 4; the measured real part radiation load resistance increased non linearly for both FIG. 3 and FIG. 4 loop arrangements. The increased inductance was tuned out by capacitor device 209. The measured effective radiated power was increased to that of a normal dipole or monopole antenna of the same electrical length. The radiation pattern of the individual loops remained the same planar low angle mostly omnidirectional. This suggests that adding loops in series may increase efficiency by increasing real part radiation resistance of the main loop and increasing the effective radiated power in the low angle plane.

FIGS. 5-8 illustrate the effect of adding planar loops, in accordance with embodiments of the disclosure. FIG. 5 shows a single round loop 202 with leads, having a total electrical length slightly less than ⅛ wavelength. The loop set of FIG. 6 has a length slightly less than ¼ wavelength total length with the two round 202 loop devices in series with leads. The loop set of FIG. 7 is slightly longer than ½ wavelength with the four round 202 loop devices and leads in series. The loop set of FIG. 8 loop set is 1 wavelength long with the eight round 202 loop devices and leads in series. FIG. 5 loop and circuit include, as above, less than ⅛ wavelength loop with leads, variable tune capacitor 208, transformer 205 and standard UHF coax connector 206. The circuit of FIG. 6 includes loops with less than ¼ wavelength, with leads, variable tune capacitor 209, transformer 205 and standard UHF coax connector 206. The circuits required are the same except capacitor 208 (FIG. 5) must be capable of a higher maximum capacitance tune value than capacitor 209 (FIG. 6) which needs to tune to a lower minimum value capacitance.

The turns ratio of the transformer in FIG. 5 transformer is preferably higher than that in FIG. 6 to match the lower real part of radiation resistance in the electrically shorter loop of FIG. 5. Comparing FIG. 7 with FIG. 6, two circuit changes are made to tune the slightly longer than ½ wavelength sets of FIG. 7 loops: The 208/209 variable capacitor devices of FIG. 5 and FIG. 6 are changed to a variable inductance device (variable inductor device 210 of FIG. 7); and the transformer device 205 turns ratio of FIG. 7 must also be decreased due to the increased real part resistance of the electrically longer total electrical length loop.

Another embodiment is shown in FIG. 8, where the planar loops and leads have a length of 1 wavelength, and only a 1:1 balun type transmission line transformer 205 is required to tune the loops to resonance. The arrangement of FIG. 8 has been found to match transmitter power input devices of approximately 50 ohms, when such loads are connected to jack 206 with a less than 1.5 to 1 SWR ratio and when the total length of FIG. 8 loop set is made to approximate a physical length of 936/(frequency in MHz) feet.

Without being bound by any theory of operation, the following observations are offered with respect to the embodiment of FIG. 1. A model to explain the load tune operation of a set of less than ½ wavelength loops in series is as follows: A length of transmission line, say open wire ladder line type, if shorted at one end and driven at the other end will act as a inductor or capacitor under two sets of conditions—if the physical length of line is increased and the frequency is held constant, or the line length is held constant and the frequency is varied. The results for the second set of conditions above are well known. As the frequency is increased from 0 frequency the reactance of a fixed length line will vary from inductive to real to capacitive to real and repeat. This case is well understood from transmission line theory. The case of increasing the length of a transmission line and holding the frequency constant also produces the same result; the reactance varies from current value for length to real to inductive or capacitive then to the next opposite type of reactance and repeats. FIGS. 5-8 illustrate the case of increasing the length of a transmission line holding frequency constant. A general high loss inside out transmission line model covering loop antennas and antennas made up of loop sets in series can be developed.

An advantage of tuning by electrical length to natural resonance without using variable inductor or variable capacitor devices is the loop sets of binary electrical length elements can be switched in or out of a series circuit and bypassed at a very fast rate (switching on the order of milliseconds). At a great distance, using low cost relays as shown in FIG. 1, the loop length can be set to get correct conditions for matched operation with 1:1 balun by switching in sets of planar coplanar and combined planar coplanar loop sets. This permits a common interface and eliminates all analog feedback control circuits and slow anti-backlash gear drives used with motor driven variable capacitors and variable coils. Another advantage is the range of this system is effectively 65000:1, which exceeds the range available from existing variable capacitors or variable coils. Another advantage is higher efficiency; the voltages across all antenna element loop sets is the same as the voltage across the coaxial cable for any given power level. Furthermore, when series variable capacitors or variable inductors are used to bring a less than or greater than one wavelength loop to resonance, the voltage across the loop is increased; the current times the reactance at frequency of the reactive elements causes this voltage. This reactive voltage is effectively added to the driving voltage from coaxial input, increasing the voltage across the loop and its elements. The heating effects of this increased voltage potential across the antenna and components is a cause of heating and this infrared heat energy loss reduces the useful radiation effective radiated power (ERP) of the antenna.

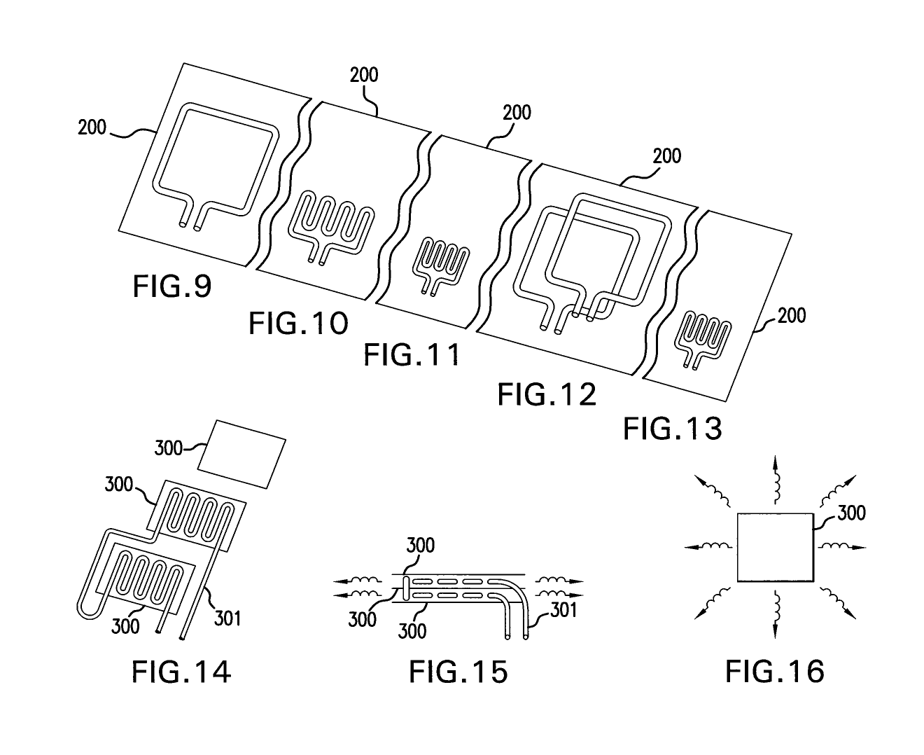

FIGS. 9-13 illustrate additional arrangements of planar and coplanar loops, in accordance with embodiments of the disclosure. It has been found that loop element spacing and loop spacing in all planes may control polarization and radiation angle and velocity factor of a loop set antenna. For this work the term “wide spaced,” when applied to individual loops, loop sets and loop element spacing, is defined as follows: The total physical series length of the loop in ft (or a section of a loop element spacing with physical length in ft) when multiplied by 0.384 micro henry/ft., corresponds to the universal permeability constant 1.26×10⁻⁶ henry/meter converted to 0.384 micro henry/ft. If the measured inductance (measured at a frequency low enough to avoid natural resonance; 10 kHz or 100 kHz are typically used) within (plus or minus) 10 percent of the above calculated inductance, then the individual loop sets or section of loop element spacing is wide spaced. The radiation from such an arrangement will be in the plane 200 as depicted in FIG. 2, FIG. 3, FIG. 4, FIG. 9 and FIG. 10. For example, if the loop element is a 128 ft physically long wire making up a planar square loop such as FIG. 9, or four series connected planar loops as in FIG. 10, and the measured inductance is within approximately 10 percent of the calculated 49.1 micro henry, the loop or loop set is wide spaced and most radiation will be in plane 200.

FIG. 11 shows a planar loop set physically 100 ft long made of four rectangular loops, each 10 ft long, on sides constructed using number 14 stranded 600 volt wire. With wire insulation in contact on sides of wires the measured inductance is 8.37 micro henry with “Q” of 7.84 at a test frequency of 100 kHz. (The “Q” or quality factor value is defined as the dimensionless ratio of energy stored in a system or component to the energy lost over a sine wave cycle at a frequency.) The measured value of inductance of 8.37 micro henry is outside the plus or minus 10 percent value range of the calculated 38.4 micro Henry value. This then is a case of closely spaced loops, this arrangement will produce mostly all angle isotropic radiation relative to plane 200.

FIG. 12 depicts two of the FIG. 9 100 ft physical length loops in a co-planar arrangement. Inductance measurements made by connecting the loops in series with connection for lowest inductance and “Q” indicate that a coplanar spacing of approximately 10 inches has no measurable effect on polarization and the wide space case is indicated by inductance measurement. With coplanar spacing less than 2.5 inch, the 10 percent point to zero spacing (zero spacing defined as wires close enough to have insulation touching) inductance measurements indicate the close spacing case and all angle isotropic radiation. FIG. 13 shows two of the FIG. 11 close spaced planar series loop sets used to empirically check the coplanar and planar narrow spaced case. When these loop sets are connected for lowest “Q” and inductance the radiation observed is all angle isotropic relative to plane 200. The fact that the spacing of loops and loop elements affects polarization is important to the design and development of embodiments of this disclosure. The FIG. 1 switching arrangement and the use with it of binary length radiating elements makes it possible to select the best path set length.

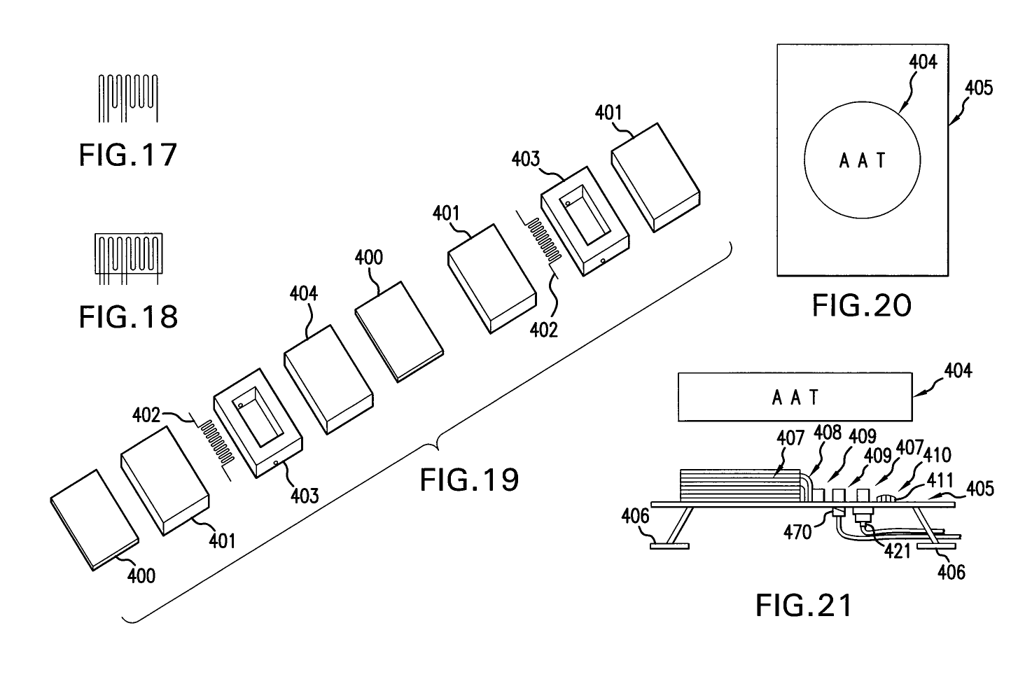

FIG. 14 depicts two four loop, planar loop sets in a coplanar combination in a series circuit connection, in accordance with another embodiment. The loop arrangement of FIG. 14 may optionally be used with three thin metal plates 300. These energy guide plates 300 are placed as depicted below in FIG. 14 and FIG. 15 in the middle and on top of the two planar loop sets as depicted in FIG. 15 (which is a side view of FIG. 14). The energy guide plates are insulated from the loop wire and each other. The use of these plates is to convert the all angle isotropic energy produced by close spaced loops into low angle omni-directional radiation shown by FIG. 16 (a top view of FIG. 14 and FIG. 15). If all angle isotropic radiation is desirable the energy guide plates can be eliminated. FIG. 17 depicts a flat wire binary length set, of three planar loops having lengths of 1 ft, 2 ft, and 4 ft. FIG. 18 also depicts a flat circuit board (possibly a printed wire board or board with stamped sheet metal) with a flat binary length set of three planar loops 1 ft, 2 ft, and 4 ft in length. FIG. 19 from left to right depicts a partial assembly of a stack 407 (shown assembled in FIG. 21) of combined planar and coplanar loop sets. Moving from left to right a 1 ft 1 inch energy guide plate or foil 400 is depicted. Next a square insulator 401, 1 ft four inches square insulator made from ⅛-inch thick plywood or Plexiglas or other suitable plastic. Next 402 depicts a 64 ft total length, 1 ft by 1 ft flat planar wire loop set made of folded number 14 solid or stranded 600 volt insulated wire. Next, 403 depicts a 1 ft 4 inch square cavity insulator made of plywood, Plexiglas or other suitable plastic, with wire holes 403 and a 1 ft square cavity in the center. Next, 401 is an insulator 1 ft four inches square made as 403 above. Next device 400 is an energy guide plate made as 400 above. Next 401 insulator is made same as 401 above. Next in FIG. 19, 402 depicts a 64 ft planar loop half of a 128 ft total loop set. Finally, 403 (cavity insulator) and 401 (insulator) complete the partial assembly illustration sequence.

Referring now to FIG. 21, this figure depicts planar loops in a stack with connection to relays 409 mounted in sockets on circuit board 411, mounted on base plate 405 with two of four mounting legs 406 of base assembly. Operation is as described for the FIG. 1 embodiment except the acceding binary length planar loop sets are stacked as shown in FIG. 19 and FIG. 21 stack 407. In addition, in this miniature version the three way connectors of FIG. 1 are eliminated and stacked loops and loop sets are connected to switch relay or other switch device by circuit board 405 mounted on base plate side view FIG. 21.

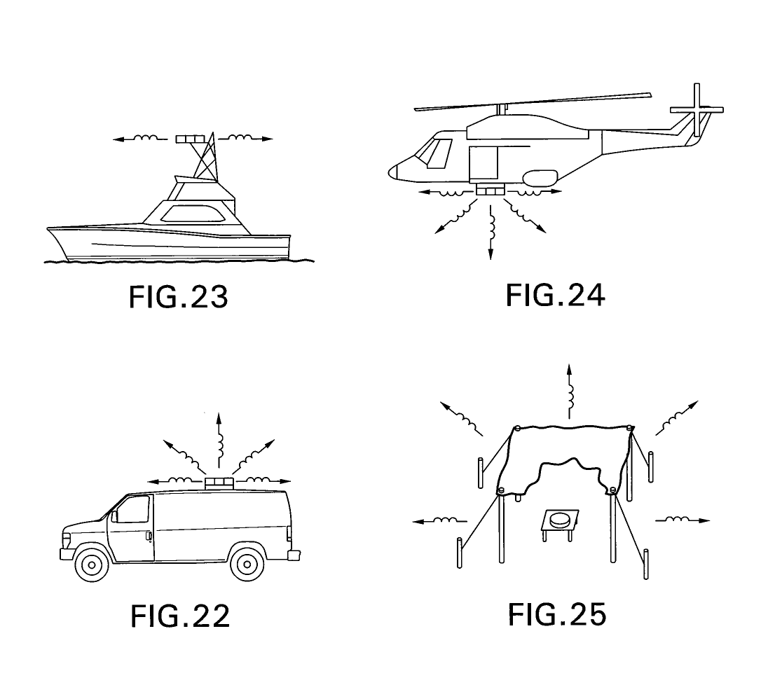

The use of devices embodying the disclosure to produce low angle omni directional radiation with energy guide plates is depicted in FIG. 23, FIG. 15 and FIG. 16. Devices using all angle isotropic radiation are depicted in FIG. 22 and FIG. 24. FIG. 20 depicts a top view of cover 404 installed on circuit board 405 base plate assembly. FIG. 21 depicts a miniature device with a radio frequency transparent cover 404 removed; stack 407 of insulated loops 408, some of the wires connecting stacked planar loops to printed 409 three of 9 relays or other switch devices performing the same function for a 1.8 to 30 MHz miniature embodiment. The balun device 410 can be a 1:1 transformer device, 411 circuit board 405 base plate 10 relays or other switching device assemblies that provide for the same function. Also the stacked planar loops with the above described assembly method, whose lengths with leads are 1 ft, 2 ft, 4 ft, 8 ft, 16 ft, 32 ft, 64 ft, 128 ft, 256 ft, 512 ft. These loop sets are wired to switch devices, as shown in ascending order in FIG. 1, and form the low profile 5 inch by 1.4 ft square loop set stack of FIG. 21.

Referring again to FIG. 1, in an additional embodiment an antenna system uses switched dipole antennas having lengths given by a binary sequence. A switching method is used in this embodiment where less than ½ wavelength dipole antennas are used as ascending binary length radiating elements in place of the ascending binary length loop or loop set radiating elements 31-46 of FIG. 1. For example, loop 31 across terminals 71, 72 in FIG. 1 is replaced with a transmission line balun device of the construction disclosed for 30. One side of this transmission line balun is connected across 71, 72. The other side of the balun is connected to one end of a coax cable electrically 2 ft long. The other end of this coax cable is connected to one side of a second balun identical to the first 30 device. This second balun device two output leads are then connected to the center of a dipole. Each side dipole wires are each six electrical inches long. Loop 32 across 73,74 is next replaced with a transmission line balun device of the construction disclosed for 30. One side of this transmission line balun is connected across 73, 74. The other side of balun is connected to one end of a coax cable electrically 4 ft long. The other end of this coax cable is connected to one side of a second balun identical to the first device 30. This second balun device two output leads are then connected to the center of a dipole. Each side dipole wires are each 1 ft electrical length long. The above procedure can be used to work out all values required to change FIG. 1 embodiment from loops or loop sets to dipoles. This embodiment is desirable in the HF frequency range to microwave frequency ranges.

In another embodiment, a switching method as in FIG. 1 is used with less than ½ wavelength monopole antennas. The monopole antennas, each with individual or common ground planes equal to monopole height in radius, are used as ascending binary length radiating elements in place of the ascending binary length loop or loop set radiating elements 31-46 of FIG. 1. For example, loop 31 across terminals 71,72 is replaced with a transmission line balun device of the construction disclosed for 30. One side of this transmission line balun is connected across terminals 71, 72. The other side of balun is connected to one end of a coax cable electrically 2 ft long. The other end of this coax cable is connected to one side of a second balun identical to the first 30 device. This second balun device has two output leads; one lead is connected to monopole, the other lead to ground plane. The monopole wire is six electrical inches in height. Loop 32 across terminals 73,74 is next replaced with a transmission line balun device of the construction disclosed for 30. One side of this transmission line balun is connected across terminals 73, 74. The other side of balun is connected to one end of a coax cable electrically 4 ft long. The other end of this coax cable is connected to one side of a second balun identical to the first device 30. This second balun device has two output leads; one lead is connected to monopole ground plane, the other to monopole wire. The monopole wire is 1 electrical ft in height. This procedure can be used to work out all values required to change FIG. 1 embodiment from loops or loop sets to monopole radiators. This embodiment is most practical from the HF frequency range to microwave frequency ranges

An additional low pass shifted harmonic resonance with binary value switched inductors embodiment under development is disclosed. Transmitting devices sometimes have harmonic energy in their output signals. The natural resonant 2, 3, 4 harmonics of arrangements such as in FIG. 1 can radiate transmitter and other harmonics. It has been theorized and empirically proven that four or more inductor devices can be used with the basic switching arrangement of FIG. 1, to un-bypass and connect and disconnect and bypass inductor devices in the same manner of FIG. 1 with loop, loop set or other binary length radiators. The correct inductance values for inductors was calculated by finding the equivalent inductance value for 8 ft, 4 ft, 2 ft and 1 ft wide spaced loops using the universal permeability constant (1.26×10⁻⁶ henry/meter) converted to 0.384 micro henry/ft. The four respective switched inductor values are 3.072 microhenry, 1.536 microhenry, 0.768 microhenry and 0.384 microhenry. In operation with the coil devices the loop is set to a length of just less than 1 wavelength and the binary coil set is switched to a value to cancel the capacitive reactance of the main loop produced by the length less than one wavelength setting. This type of operation results in the antennas natural resonate frequency series 2, 3, 4, 5 harmonic radiating series being shifted off the operating frequency of the transmitter and the effective suppression of its 2, 3, 4, 5 harmonic series. Most modem transmitters and amplifier devices have filters to prevent and suppress harmonics. The above low pass shifted harmonic resonance using binary switched inductor devices embodiment will be of most use when active devices are used to replace the electromechanical switches of FIG. 1. Active devices in this case include such devices or arrangements of devices as, solid state diode, transistor devices, thermionic, gas tube or other types of active devices. All active devices are nonlinear over parts of their ranges when clean of harmonic energy signals from modern transmitters and amplifiers is switched through such devices a harmonic series of signals will be generated shifting the antenna harmonic series of the fundamental frequency will suppress low pass filter such harmonics. The use of active elements will permit the antenna tuned resonant frequency to be shifted under very high-speed conditions for some applications of invention. Shifting of the harmonic series using a set of binary value switch capacitor devices is also a possibility for some applications probably receive only versions or low power portable light weight transmit versions of the antenna.

Other additional embodiments include an interface to a frequency counter module for a computer to read frequency and remember settings and software to map setting for all bands and auto switch antenna. A relay under software control to disable transmitter to amplifier keying PTT (push to talk) and or relay with voltage to ALC (automatic level control) line of amplifier to reduce power during tuning.

FIGS. 22 to 25 depict some typical applications for miniature close spaced low profile embodiments of the disclosure.

An alternative 24 volt 60 cycle AC relay device that has been used in place of the sixteen 12 volt DC relays described above for relays 51-66 is the type “Tyco Electronics Potter & Brumfield” (Philadelphia, Pa.), and are type ”PRD-11AGO-24 24 volt 50.60 HZ DPDT TYPE 10 amp, 600 volt rated contacts.” The 12 VDC source 20 must be replaced by a 24 volt transformer; all other above-described control operations are the same as described but at 24 VAC.

Again referring to FIG. 1, and coax UHF type panel jack 28: A coaxial type lightning arrestor device required by electrical code for outside use with a direct to earth ground should be installed. This lightning safety earth ground is not used for transmitting or receiving by antenna.

The type of conductor used to construct the radiating loops is determined by structural and RF power level of operation. Individual loops of inside parameter and leads less than ½ wavelength have been made and combined into loop sets of various loop shapes from conductors such as IDC Type 3M3625 SERIES 1.0 MM ROUND CONDUCTOR FLAT CABLE 3M PART NO. 3625/50 ribbon wire. In this case all fifty of the individual number 28 stranded wire conductors are connected in parallel at each end. Copper strips as well as aluminum strips, copper, foil strips, copper tube, aluminum tube, #14 stranded wire, solid wire and many mixed conductors may be used to construct binary length loop sets.

Loop shapes including square, round and rectangular loops have been tested and found to perform as described above; accordingly, a wide variety of freestanding structures are possible where loops and insulating structural members are combined to form freestanding remote tunable structures.

In alternative embodiments, other components may be used to perform the functions of the various devices shown in FIG. 1. For example, the direct substitution of individual solid state devices for FIG. 1 electromechanical relay devices to accomplish the same switch function; the substitution of other types of electromechanical or other switch devices performing the same switch function as FIG. 1 relay devices; and the substitution of any solid state devices and other components, such as transformers, diodes, transistors, resistors, capacitors, inductors in any and all circuit combinations to perform the function of the FIG. 1 electromechanical relay devices. An embodiment has been described with reference to FIG. 1, with loop set lengths required for binary operation and manual control switch box that can be used to operate the antenna under manual control. It will be appreciated that it is often preferred to operate the antenna system remotely and/or under computer automatic control. Arrangements including the relay switching device and loop sets of FIG. 1, and including automatic remote control, are described below.

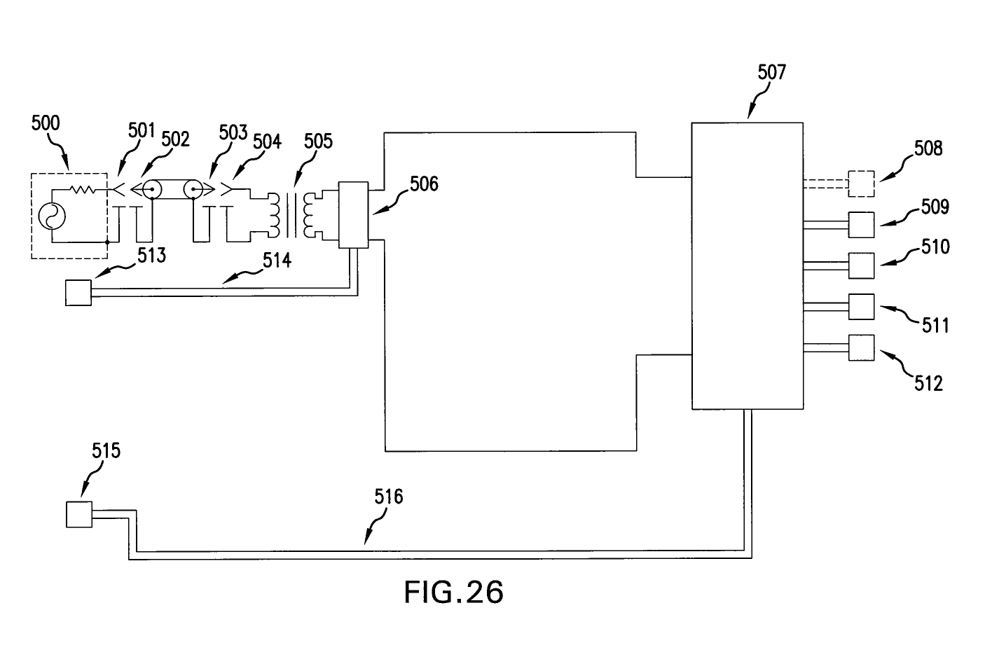

FIG. 26 illustrates an antenna system according to a further embodiment of the disclosure, and including the relay switching device and radiating elements described in FIG. 1. Block 500 indicates a standard shielded transmitter device with signal frequency Fₒ of type function K sin(2 π Fₒ t+0) voltage source, with an internal series resistance of 50 ohms. UHF type coaxial jack 501 connects by coaxial cable with UHF type coaxial plug 502 to balun device 505 by 50 ohm coaxial cable through UHF type coaxial plug 503 to balun device UHF type coaxial jack 504. Balun device 505 connects to standing wave ratio (SWR) detector device 506, which is connected to remote indicator device 513 by monitor wiring buss 514. Device 507 is the relay switching device as described with reference to FIG. 1, and used to set antenna electrical length by switching by remote control; Remote control 515 connects to relay switching device 507 via wire buss 516. As described above, planar or co-planar series connected antenna loop sets of binary length 1, 2, 4, 8, 16,3 2, 64, 128, 256 etc. are switched in and out; five of the typical ten sets of planar loops are indicated at 508-512.

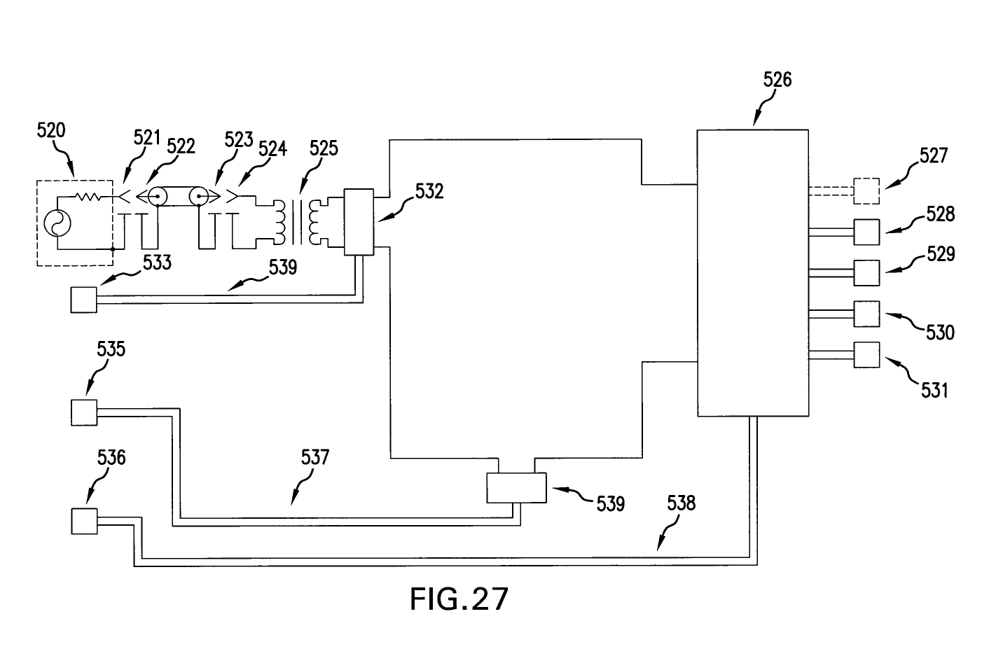

FIG. 27 illustrates another antenna system with some features similar to FIG. 26. As in FIG. 26, block 520 depicts a standard shielded transmitter device with signal frequency Fₒ of type function K sin(2 π Fₒ t+0) voltage source, with internal series resistance of 50 ohms. UHF type coaxial jack 521 connects by coaxial cable with UHF type coaxial plug 522 to balun device 525 through UHF type coaxial plug 523 to balun UHF type coaxial jack 524. Balun device 525 connects to standing wave ratio (SWR) detector device 532, which is connected to remote indicator device 533 by monitor wiring buss 534. Device 526 is the relay switching device as described with reference to FIG. 1, and used to set antenna electrical length by switching by remote control. Remote control 536 connects to device 526 by wire buss 538. Planar or co-planar series connected antenna loop sets of binary length 1, 2, 4, 8, 16, 32, 64, 128, 256 etc. are switched in and out as described with reference to FIG. 1. Five of the typical ten sets of planar loops are shown at 527-531. Device 539 is a remote controlled variable inductance device in series with SWR detector device 532 and relay switching device 526. The remote control 535 for device 539 is connected by buss cable 537.

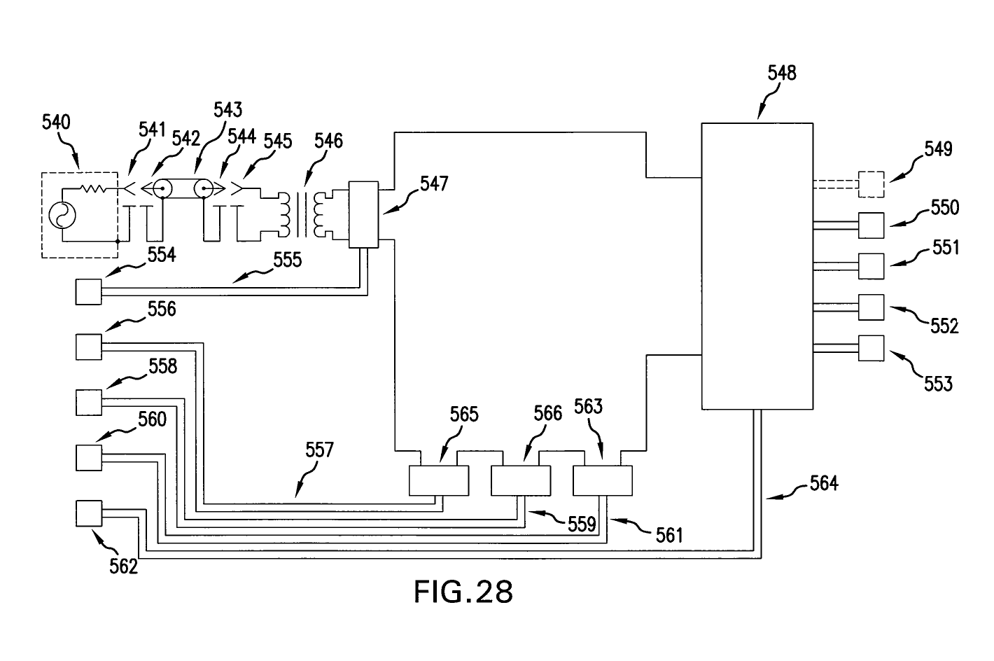

FIG. 28 illustrates a further development of the antenna system with some features similar to FIG. 27. Block 540 depicts a standard shielded transmitter device with signal frequency Fₒ of type function K sin(2 π Fₒ t+0) voltage source, with internal series resistance of 50 ohms. Output UHF type coaxial jack 541 connects by coaxial cable 543 with UHF type coaxial plug 542 to balun device 546, via UHF type coaxial plug 544 to balun UHF type coaxial jack 545. Balun device 546 connects to SWR detector device 547, which is connected to remote indicator device 554 by monitor wiring buss 555. SWR detector device 547 is connected in series with devices 565, 566, 563, each of which are connected to respective remote control and indicator devices 556, 558, 560 by buss cables 557, 559, 561. Device 565 is a remote controlled capacitor device, and device 566 is a remote controlled variable inductance device. Device 563 is connected in series with relay switching device 548, used to set antenna electrical length by switching by remote control 562, connected by wire buss 564. Planar or co-planar series connected antenna loop sets of binary length 1, 2, 4, 8, 16, 32, 64, 128, 256 etc. length are switched in and out as described with reference to FIG. 1. Five of the typical ten sets of planar loops are shown at 549-553.

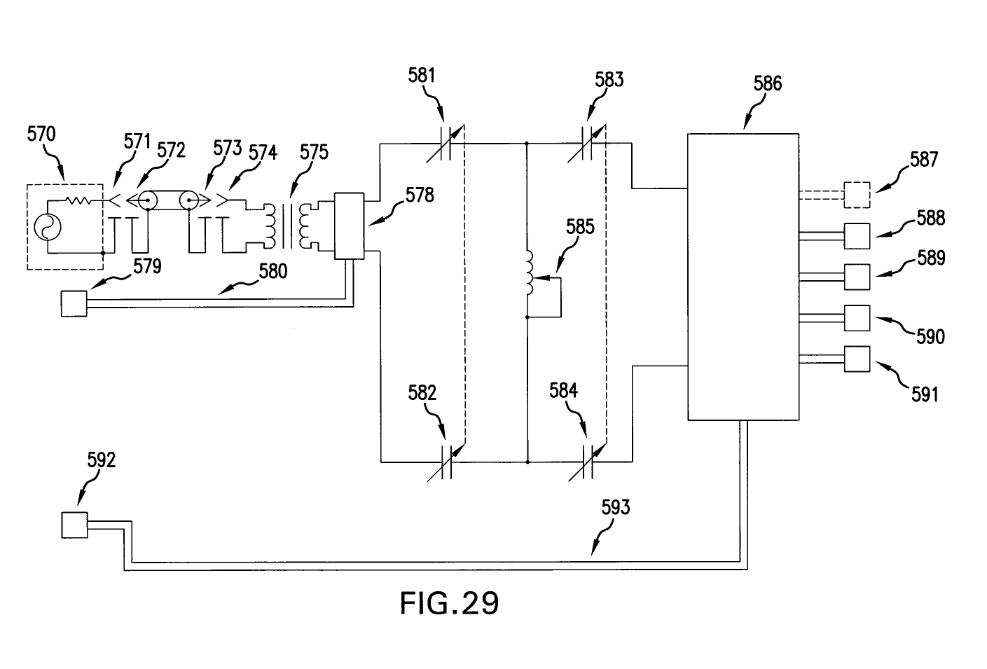

FIG. 29 illustrates an antenna system according to an embodiment of the disclosure, with features similar to those in FIGS. 26-28. Block 570 depicts a standard shielded transmitter device with signal frequency Fₒ of type function K sin(2 π Fₒ t+0) voltage source, with internal series resistance of 50 ohms. Output UHF type coaxial jack 571 connects by 50 ohm coaxial cable with UHF type coaxial plug 572, and by 50 ohm coaxial cable to UHF type coaxial plug 573 and UHF type coaxial jack 574 to balun device 575. Balun device 575 connects to SWR detector device 578, which is connected to remote indicator device 579 by monitor wiring buss 580. SWR detector device 578 is connected in series with device 581 (a variable capacitor device mechanically ganged to capacitor device 582 by a insulated shaft such that both devices are set to the same capacitance value). A variable inductance device 585 is connected across capacitor devices 581, 582. A variable capacitor device 583 is connected between the junction of 584 and 585 in series to device 586, which is a relay switching device described above with reference to FIG. 1. Variable capacitor device 584 is connected between the junction of 581 and 585 in series to device 586. Variable capacitor device 583 is mechanically ganged to capacitor device 584 by a insulated shaft such that both devices are set to the same capacitance value. Relay switching device 586 is used to set antenna electrical length by switching by remote control. Remote control 592 is connected to device 586 by wire buss 593. Planar or co-planar series connected antenna loop sets of binary length 1, 2, 4, 8, 16, 32, 64, 128, 256 etc. are switched in and out as described for FIG. 1 operation. Five of the typical ten planar loop sets are shown at 587-591. The circuit shown in FIG. 29 is a twin “T” balanced matching network connected from the two output leads of SWR detector 578 to relay switching device 586 used to set antenna electrical length.

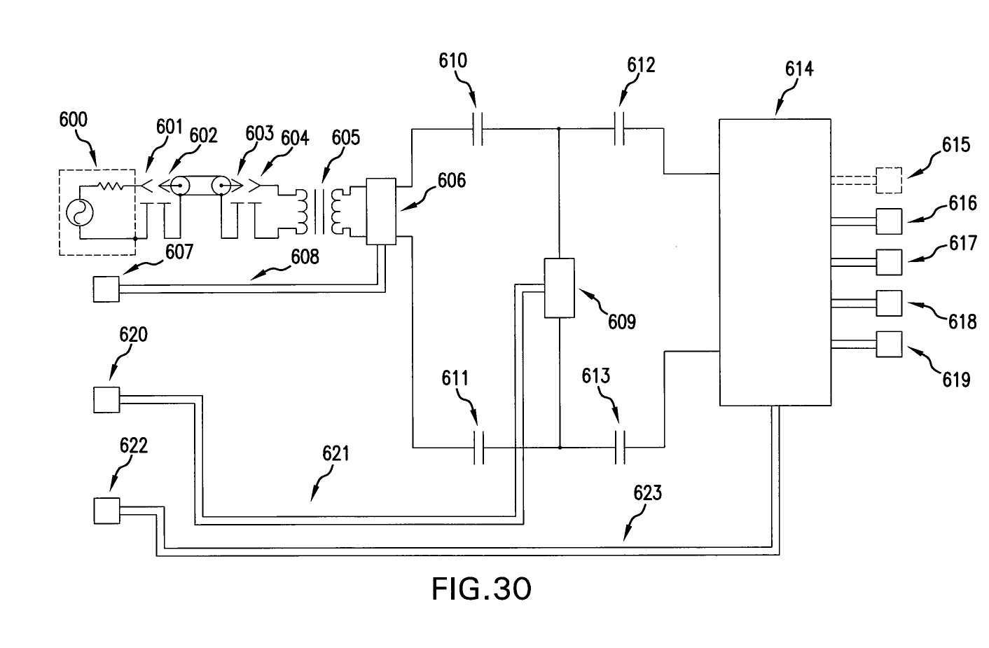

FIG. 30 illustrates an antenna system with some features similar to FIGS. 26-29. Block 600 depicts a standard shielded transmitter device with signal frequency Fₒ of type function K sin(2 π Fₒ t+0) voltage source, with internal series resistance of 50 ohms. Output UHF type coaxial jack 601 connects by coaxial cable through UHF type coaxial plug 602 to balun device 605, by UHF type coaxial plug 603 to balun UHF type coaxial jack 604. Balun device 605 connects to SWR detector device 606, which is connected to remote indicator device 607 by monitor wiring buss 608. SWR detector device 606 connects in series with fixed value capacitor 610, fixed value capacitor 612, and relay switching device 614 (described above with reference to FIG. 1).

As shown in FIG. 30, SWR detector device 606 is also connected in series with fixed value capacitor 611 and fixed value capacitor 613, which connects to relay switching device 614. Device 614 is used to set antenna electrical length by switching by remote control. Remote control 622 is connected to device 614 by wire buss 623. Planar or co-planar series connected antenna loop sets of binary length 1, 2, 4, 8, 16, 32, 64, 128, 256 etc. are switched in and out as described with reference to FIG. 1. Five of the typical ten planar loop sets are shown at 615-619.

Remote controlled variable binary value switched inductor device 609 is connected from the junction of devices 610, 612 to the junction of devices 611, 613 to form a twin “T” balanced matching network, where the antenna electrical length is set by device 614 to ⅝ to ⅞ wavelength and resonance of the network is set by binary value switched inductance device 609. Device 609 is controlled by a remote device 620, connected to device 609 by wire buss 621.

A specific embodiment, as shown schematically in FIG. 30, has been constructed as follows:

Fixed capacitor device 612 is made up from two fixed value 2 pf 25,000 volt DC vacuum capacitor devices in series to form a 1 pf 50,000 volt DC device.

Fixed capacitor device 613 is made up from two fixed value 2 pf 25,000 volt DC vacuum capacitor devices in series to form a 1 pf 50,000 volt DC device.

Fixed capacitor device 610 is one 300 pf 25,000 volt DC vacuum capacitor device.

Fixed capacitor device 611 is one 300 pf 25,000 volt DC vacuum capacitor device.

Remote controlled variable inductor device 609 is made of air coil inductor devices switched in out and bypassed by relays.

The total inductance value is 512 micro henrys. This device uses inductor values; 256 micro henrys, 128 micro henrys, 64 micro henrys, 32 micro henrys, 16 micro henrys, 8 micro henrys, 4 micro henrys, 2 micro henrys, 1 micro henry.

The coplanar loop sets are constructed in the form of FIGS. 17 and 19 in a stack such as shown in FIG. 21, with parallel series loop wires spaced 0.5 inch and 12 inches long. Referring to FIG. 19, number 10 stranded 600 volt wire 402 was stapled onto ⅛ thick spacer board 401, then a cavity spacer board 403, ⅛ inch thick, was placed over wire; the next ⅛ inch spacer board 401 provides an approximate 0.5 inch space between coplanar loop sets.

An antenna system according to the disclosure offers important advantages in that it is both compact and tunable. Referring again to the antenna system shown in FIG. 30, and without being bound by any theory of operation, suppose that the transmitter AC voltage from transmitter section 600 is given by

v(t)=K sin(2 π Fₒ t)

where Fₒ is the transmitter frequency. The peak voltage K may be evaluated from the RMS power input to the transmitter, and the transmitter series resistance R. The antenna may be tuned, using relay switching device 614, so that the antenna electrical length is less than or equal to one wavelength at Fₒ. The input current as a function of time is

i(t)=v(t)/R=K sin(2 π Fₒ t)/R

and the power input

p(t)=i(t)²R=K² sin²(2 π Fₒ t)/R

The energy input forcing function j(t)=d/dt p(t)

j(t)=2K² sin(2 π Fₒ t) cos(2π Fₒ t) 2π Fₒ/R=(2π Fₒ K²/R) sin(4π Fₒ t)

and the total energy input over one RF cycle

E=∫p(t) dt=K²/2RFₒ

and applying conservation of energy,

E=|IR|+|RF|

where IR and RF represent infrared energy radiation and radio frequency energy radiation, respectively, and |x| denotes absolute value or magnitude: |x|=sqrt(x²).

The RF energy into the antenna at the frequency of operation Fₒ is split and converted by the antenna into radiated IR heat energy and radiated RF energy according to the ratio of the antenna wire physical length to the radiation wavelength:

antenna wire physical length=x

radiation wavelength=λ

E=|(1−(x/λ))E|+|(x/λ)E|

where the first term is the IR heat radiation term and the second term is the RF radiation term. The balance between IR and RF radiation thus depends on the antenna length relative to the wavelength of radiation. If the antenna total physical length is ½ the wavelength, IR radiation equals RF radiation. If the antenna total physical length is much less than the wavelength, nearly all the radiation is IR heat radiation. If the antenna total physical length is equal to the wavelength, nearly all the radiation is RF radio frequency radiation. This has been observed for the long electrical length, folded conductor antennas described herein, despite the compactness of the overall system. Antenna systems embodying the present disclosure therefore offer significant practical advantages.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

I claim:

1. An antenna system comprising:
a plurality of conductors of differing lengths;
a switching device coupled to each of the conductors;
a transformer coupled to the switching device; and
a device for remote control of the switching device,
wherein
the switching device is effective to connect selected conductors in series, to obtain an antenna of a desired electrical length, and
the conductors are folded so that a length of the antenna system is less than said electrical length.

2. An antenna system according to claim 1, wherein the conductors are insulated from each other.

3. An antenna system according to claim 1, wherein the transformer is a 1:1 balun device.

4. An antenna system according to claim 1, wherein the switching device comprises a plurality of relays, each of said relays coupled to one conductor so that a given relay when energized causes said conductor to be switched into the antenna.

5. An antenna system according to claim 1, wherein the conductors include sets of planar loops, coplanar loops, and/or planar and coplanar loops in combination.

6. An antenna system according to claim 4, wherein
the conductors have electrical lengths relative to each other according to a binary sequence, and
the relays coupled to the conductors are energized according to a binary control bit pattern transmitted from the remote control device, thereby obtaining an antenna with an electrical length in accordance with a value associated with the binary control bit pattern.

7. An antenna system according to claim 6, wherein the relay coupled to the shortest conductor represents the least significant bit of the control bit pattern, and the relay coupled to the longest conductor represents the most significant bit of the control bit pattern.

8. An antenna system according to claim 6, further comprising a standing wave ratio (SWR) detector coupled to the transformer, and wherein the switching device is effective to tune the antenna system to minimize the SWR.

9. An antenna system according to claim 5, wherein at least one of the conductors is a set of stacked loops having a rectangular or circular shape.

10. An antenna system according to claim 5, wherein the antenna is configured to radiate at a selected wavelength, and each loop has an electrical length of less than ½ of said wavelength.

11. An antenna system according to claim 10, wherein the set of loops is configured to produce low angle, linearly polarized, omnidirectional horizontal radiation.

12. An antenna system according to claim 10, wherein the set of loops is configured to produce all angle, isotropic, unpolarized radiation.

13. An antenna system according to claim 8, further comprising a tuning circuit connected in series between the SWR detector and the switching device, the tuning circuit including a variable inductance and a variable capacitance.

14. An antenna system comprising:
a transmitter section for transmitting RF radiation at a given frequency;
a transformer coupled to the transmitter section;
a standing wave ratio (SWR) detector connected to the transformer;
a balanced matching network including two terminals, each terminal of the balanced matching network connected to the SWR detector through a fixed capacitance;
a relay switching device connected to the balanced matching network, each terminal of the balanced matching network connected to the relay switching device through a fixed capacitance;
a plurality of antenna elements of varying lengths, each connected to the relay switching device;
a remote indicator device connected to the SWR detector;
a matching network remote control device connected to the balanced matching network; and
a relay switching remote control device connected to the relay switching network,
wherein
the relay switching device includes one relay coupled to each of the antenna elements, so that a given relay when energized switches the corresponding antenna element into an antenna.

15. An antenna system according to claim 14, wherein the transformer is a 1:1 balun device.

16. An antenna system according to claim 14, wherein the antenna elements include sets of planar loops, coplanar loops, and/or planar and coplanar loops in combination.

17. An antenna system according to claim 16, wherein at least one of the antenna elements is a set of stacked loops having a rectangular or circular shape.

18. An antenna system according to claim 14, wherein
the antenna elements have electrical lengths relative to each other according to a binary sequence, and
the relays are energized according to a binary control bit pattern transmitted from the relay switching remote control device, thereby obtaining an antenna with an electrical length in accordance with a value associated with the binary control bit pattern.

19. An antenna system according to claim 18, wherein the plurality of antenna elements includes ten sets of planar loops, coplanar loops, and/or planar and coplanar loops in combination, and the antenna elements have electrical lengths relative to the shortest element by factors of 1, 2, 4, 8, 16, 32, 64, 128, 256, and 1024 respectively.

20. An antenna system according to claim 14, wherein
the balanced matching network is configured as a twin “T” balanced matching network,
the relay switching device is controlled to obtain an antenna with an electrical length between about ⅝ and ⅞ of a desired radiation wavelength, and
the balanced matching network is controlled to obtain resonance of the network.
